(19) United States
(12) Patent Application Publication
(10) Pub. No.: US 2025/0102964 A1
(43) Pub. Date: Mar. 27, 2025

(54) DEVELOPING DEVICE AND IMAGE FORMING APPARATUS

(71) Applicant: FUJIFILM Business Innovation Corp., Tokyo (JP)

(72) Inventors: Yujiro FUKUDA, Kanagawa (JP); Kenta URAYAMA, Kanagawa (JP); Shota OBA, Kanagawa (JP)

(73) Assignee: FUJIFILM Business Innovation Corp., Tokyo (JP)

(21) Appl. No.: 18/592,471

(22) Filed: Feb. 29, 2024

(30) Foreign Application Priority Data
Sep. 26, 2023 (JP) 2023-163720

(51) Int. Cl. G03G 15/09

(52) U.S. Cl. CPC G03G 15/0921

(57) ABSTRACT

A developing device includes a developer holder in which a stick region as a region where a developer containing toner and carrier is stuck is set excluding an end portion, and that holds the developer to be supplied to an image holder forming an electrostatic latent image, in the stick region; a magnetic plate that is positioned at the end portion of the developer holder in a second range excluding a first range in a circumferential direction; and magnets that are combined to form a magnetization pattern in the circumferential direction corresponding to the first range.

### CROSS-REFERENCE TO RELATED APPLICATIONS

This application is based on and claims priority under 35 USC 119 from Japanese Patent Application No. 2023-163720 filed Sep. 26, 2023.

### BACKGROUND

### (i) Technical Field

The present invention relates to a developing device and an image forming apparatus.

### (ii) Related Art

For example, JP2004-354855A discloses a developing apparatus including a developer container filled with a developer; a developing sleeve that includes a built-in magnet, is rotatably attached to an opening portion of the developer container, and conveys the developer to an electrostatic latent image formed on a photoreceptor; and a magnetic seal member of which NS poles are multipolar-magnetized on an inner peripheral surface and which is arranged at both end portions of the developing sleeve with a predetermined distance away from the outer peripheral surface of the developing sleeve, in which the NS poles multipolar-magnetized on the inner peripheral surface are magnetized diagonally with respect to a longitudinal direction of the developing sleeve.

### SUMMARY

Here, in the developer holder in which a stick region as a region where the developer containing toner and carrier is stuck is set by the internal arrangement of magnets and which holds the developer supplied to the image holder forming the electrostatic latent image, in the stick region, toner leaks at the end portion where the magnets are not arranged inside to contaminate the inside and outside of the developing device. In order to prevent such toner leakage, a configuration may be considered in which a magnet and a magnetic plate are additionally arranged at the end portion of the developer holder. However, depending on the configuration of the end portion, it may be difficult to additionally arrange at least one of the magnet or the magnetic plate over the entire circumference of the end portion, and in such cases, it is necessary to change the component parts or the like.

Aspects of non-limiting embodiments of the present disclosure relate to a developing device and an image forming apparatus that suppress an increase in cost for preventing toner leakage as compared with a case where component parts are changed in order to arrange a magnet and a magnetic plate over the entire circumference of the end portion.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including a developer holder in which a stick region as a region where a developer containing toner and carrier is stuck is set excluding an end portion, and that holds the developer to be supplied to an image holder forming an electrostatic latent image, in the stick region; a magnetic plate that is positioned at the end portion of the developer holder in a second range excluding a first range in a circumferential direction; and magnets that are combined to form a magnetization pattern in the circumferential direction corresponding to the first range.

### BRIEF DESCRIPTION OF THE DRAWINGS

Exemplary embodiment(s) of the present invention will be described in detail based on the following figures, wherein:

FIG. 1 is a diagram illustrating an image forming apparatus;

FIG. 2 is a diagram illustrating a developing device of the image forming apparatus;

FIG. 3 is a perspective view illustrating a more specific configuration of the developing device;

FIG. 4 is a cross-sectional view of the developing device viewed from an inner surface side of a front side member;

FIG. 5 is a cross-sectional view illustrating a relationship between a developing roll, metal plates, and a sheet magnet;

FIG. 6 is a perspective view illustrating the relationship between the developing roll, the metal plates, and the sheet magnet;

FIG. 7 is a diagram illustrating a first form example of a magnetization pattern;

FIG. 8 is a diagram illustrating a second form example of a magnetization pattern;

FIG. 9 is a diagram illustrating a third form example of a magnetization pattern; and

FIG. 10 is a diagram illustrating a fourth form example of a magnetization pattern.

### DETAILED DESCRIPTION

Hereinafter, exemplary embodiments of the invention will be described in detail with reference to the accompanying drawings.

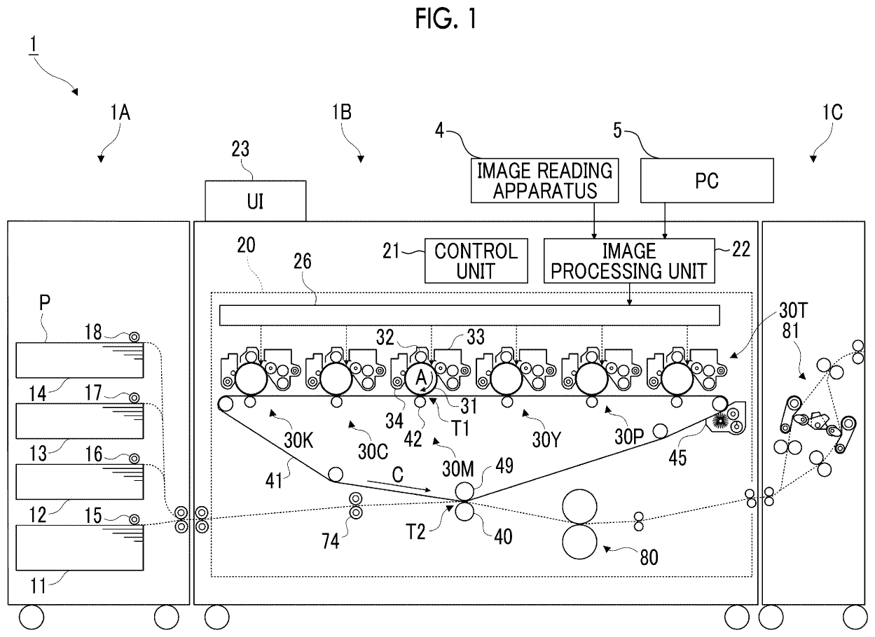

FIG. 1 is a diagram illustrating an image forming apparatus 1.

The image forming apparatus 1 according to the present exemplary embodiment includes a paper feeding unit 1A, a printing unit 1B, and a paper discharge unit 1C.

The paper feeding unit 1A includes a first paper accommodation portion 11 to a fourth paper accommodation portion 14 that accommodate paper P as an example of a recording medium.

In addition, the paper feeding unit 1A is provided with feeding rolls 15 to 18 that are provided respectively corresponding to the first paper accommodation portion 11 to the fourth paper accommodation portion 14, and that feed the paper P accommodated in each paper accommodation portion to a conveyance route connected to the printing unit 1B.

The printing unit 1B includes an image forming portion 20 that forms an image on the paper P. In addition, the printing unit 1B is provided with a control unit 21 that controls each unit of the image forming apparatus 1.

In addition, the printing unit 1B also includes an image processing unit 22. The image processing unit 22 performs image processing on image data transmitted from an image reading apparatus 4 and a personal computer (PC) 5.

In addition, the printing unit 1B is provided with a user interface (UI) 23 that is configured by a touch panel or the like and that notifies a user of information and receives an input of information from the user.

The image forming portion 20 as an example of an image forming section is provided with six image forming units 30T, 30P, 30Y, 30M, 30C, and 30K (hereinafter simply referred to as “image forming unit 30”) arranged in parallel at regular intervals.

Each image forming unit 30 includes a photosensitive drum 31 on which an electrostatic latent image is formed while rotating in a direction of arrow A, a charging roll 32 that charges a surface of the photosensitive drum 31, a developing device 33 that develops the electrostatic latent image formed on the photosensitive drum 31, and a drum cleaner 34 that removes toner or the like on the surface of the photosensitive drum 31.

The photosensitive drum 31 is an example of an image holder.

In addition, the image forming portion 20 is provided with a laser exposure device 26 that exposes each photosensitive drum 31 of each image forming unit 30 with laser light.

Note that the exposure of the photosensitive drum 31 by the laser exposure device 26 is not limited to using laser light. For example, each image forming unit 30 may be provided with a light source such as a light emitting diode (LED), and the exposure of the photosensitive drum 31 may be performed using light emitted from the light source.

The respective image forming units 30 have a similar configuration except for the toner housed in the developing device 33. The image forming units 30Y, 30M, 30C, and 30K form yellow (Y), magenta (M), cyan (C), and black (K) toner images, respectively.

In addition, the image forming units 30T and 30P form toner images using toner corresponding to corporate colors, foamed toner for braille, fluorescent toner, toner to improve glossiness, and the like. In other words, the image forming units 30T and 30P form toner images using special color toner.

In addition, the image forming portion 20 is provided with an intermediate transfer belt 41 to which the toner image of each color formed on the photosensitive drum 31 of each image forming unit 30 is transferred.

In addition, the image forming portion 20 is provided with a primary transfer roll 42 that transfers each color toner image of each image forming unit 30 onto the intermediate transfer belt 41 at a primary transfer portion T1.

In addition, the image forming portion 20 is provided with a secondary transfer roll 40 that transfers the toner images transferred onto the intermediate transfer belt 41 all at once onto the paper P at a secondary transfer portion T2.

Further, the image forming portion 20 is provided with a belt cleaner 45 that removes toner or the like on the surface of the intermediate transfer belt 41, and a fixing device 80 that fixes the secondarily transferred image onto the paper P.

The image forming portion 20 performs an image forming operation on the basis of a control signal from the control unit 21.

Specifically, in the image forming portion 20, first, image processing is performed by the image processing unit 22 on the image data input from the image reading apparatus 4 or the PC 5, and the image data after the image processing is performed is supplied to the laser exposure device 26.

Then, for example, in the image forming unit 30M for magenta (M), after the surface of the photosensitive drum 31 is charged by the charging roll 32, the photosensitive drum 31 is irradiated by the laser exposure device 26 with the laser light modulated with the image data obtained from the image processing unit 22.

In this manner, the electrostatic latent image is formed on the photosensitive drum 31.

The formed electrostatic latent image is developed by the developing device 33, and a magenta toner image is formed on the photosensitive drum 31.

Similarly, in the image forming units 30Y, 30C, and 30K, yellow, cyan, and black toner images are formed, and in the image forming units 30T and 30P, special color toner images are formed.

Each color toner image formed in each image forming unit 30 is sequentially electrostatically transferred by the primary transfer roll 42, onto the intermediate transfer belt 41 that rotates in a direction of arrow C in FIG. 1, and superimposed toner images are formed on the intermediate transfer belt 41.

The superimposed toner images formed on the intermediate transfer belt 41 are conveyed to the secondary transfer portion T2 that is configured by the secondary transfer roll 40 and a backup roll 49, as the intermediate transfer belt 41 is moved.

On the other hand, the paper P is taken out from the first paper accommodation portion 11 by, for example, the feeding roll 15, and then is conveyed to a position of a registration roll 74 via the conveyance route.

In a case where the superimposed toner images are conveyed to the secondary transfer portion T2, the paper P is supplied from the registration roll 74 to the secondary transfer portion T2 at the same time.

Then, at the secondary transfer portion T2, the superimposed toner images are electrostatically transferred all at once onto the paper P by the action of a transfer electric field formed between the secondary transfer roll 40 and the backup roll 49.

Thereafter, the paper P on which the superimposed toner images have been electrostatically transferred is conveyed to the fixing device 80.

In the fixing device 80, the paper P on which the unfixed toner image is formed is pressurized and heated, and fixing processing of the toner image on the paper P is performed.

Then, the paper P on which the fixing processing has been performed is conveyed to a paper stacking portion (not illustrated) after passing through a curl correction portion 81 provided in the paper discharge unit 1C.

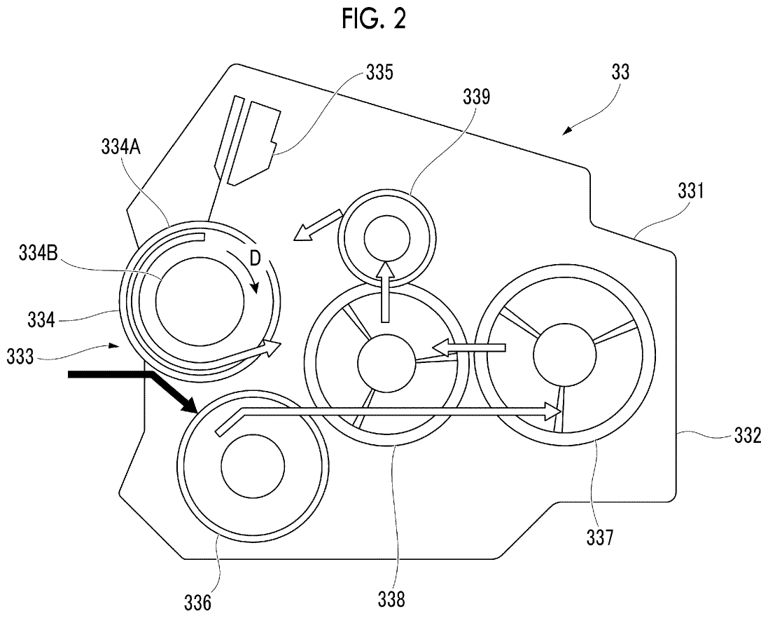

FIG. 2 is a diagram illustrating the developing device 33 of the image forming apparatus 1.

The developing device 33 includes an accommodation portion 331 that accommodates a developer (not illustrated) therein. The accommodation portion 331 is configured by an accommodation case 332 made of resin.

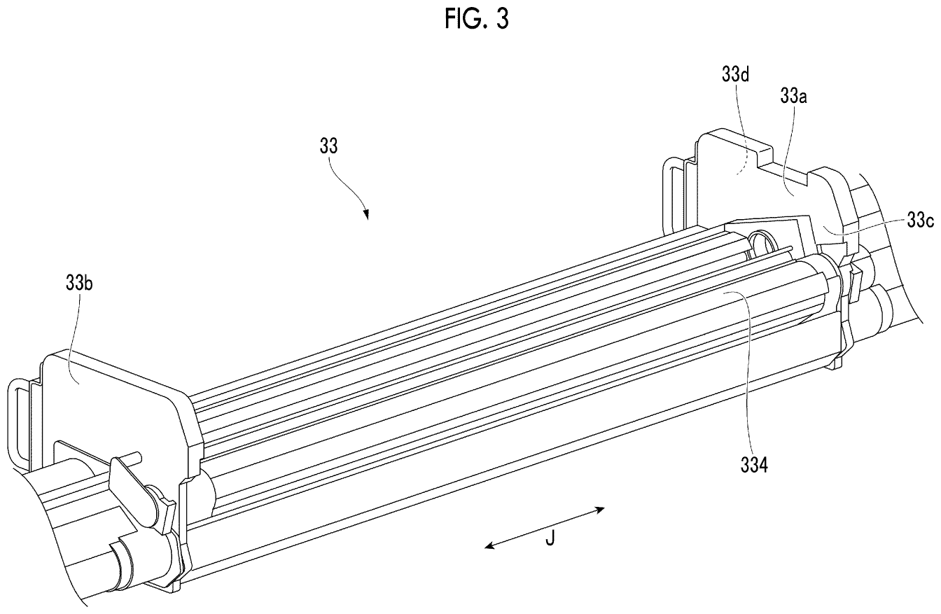

The accommodation case 332 of the developing device 33 is arranged to extend along a direction perpendicular to the paper surface of FIG. 2, which is a direction from the front side to the rear side of the image forming apparatus 1 (refer to FIG. 1), and has a front side member 33a (refer to FIG. 3) on the front side and a back side member 33b (refer to FIG. 3) on the rear side.

The accommodation case 332 is provided with an opening portion 333 at a location facing the photosensitive drum 31 (refer to FIG. 1). A developing roll 334 that causes the developer to adhere to the surface of the photosensitive drum 31 is provided in the opening portion 333.

The developing roll 334 as an example of the developer holder is formed in a cylindrical shape, and is arranged to extend along the direction from the front side to the rear side of the image forming apparatus 1. Additionally, the developing roll 334 is arranged along a longitudinal direction of the developing device 33.

The developing roll 334 is provided with a developing sleeve 334A that is configured by a cylindrical body and is rotationally driven, and with a magnet roll 334B arranged on the inner side of the developing sleeve 334A.

The developing sleeve 334A is configured by metal such as SUS, for example. In addition, the developing sleeve 334A rotates in a direction of arrow D in the figure.

The developing roll 334 is an example of the developer holder.

Further, in the present exemplary embodiment, the developing sleeve 334A and the photosensitive drum 31 rotate such that the developing sleeve 334A and the photosensitive drum 31 are moved in the same direction at the primary transfer portion T1 (refer to FIG. 1) between the developing roll 334 and the photosensitive drum 31.

The developing device 33 is provided with a layer regulating member 335 that regulates a layer thickness of the developer held on the developing roll 334.

In addition, as illustrated in FIG. 2, the developing device 33 is provided with a first conveyance member 336 and a second conveyance member 337 that convey the developer.

The first conveyance member 336 and the second conveyance member 337 are provided on a side opposite to the side where the photosensitive drum 31 (refer to FIG. 1) is installed, with the developing roll 334 interposed therebetween.

The first conveyance member 336 includes a rotation axis along a rotation axis of the developing sleeve 334A that is rotationally driven, rotates around the rotation axis, and conveys the developer in the accommodation portion 331.

In the developing device 33 configured as described above, new toner or toner to which a very small amount of carrier is added is conveyed in circulation by being agitated and conveyed between the first conveyance member 336 and the second conveyance member 337. More specifically, by delivering the developer through connection ports formed at both ends of a partition wall extending in an axial direction, the developer agitated by the first conveyance member 336 is agitated by the second conveyance member 337, and can be further agitated by the first conveyance member 336. In the developing device 33, circulation routes as routes circulating in the axial direction due to the rotation of each of the first conveyance member 336 and the second conveyance member 337 are formed.

In the developing device 33, a third conveyance member 338 adjacent to the second conveyance member 337 is provided. In addition, in the developing device 33, a pickup roll 339 positioned above the third conveyance member 338 is provided.

The conveyance route formed by the rotation of the third conveyance member 338 is connected to the above-mentioned circulation route, and the developer from the circulation route is delivered. The third conveyance member 338 supplies the developer to the pickup roll 339. The pickup roll 339 supplies the developer to the developing roll 334.

For example, the first conveyance member 336 performs the conveyance to the front side of the paper surface, the second conveyance member 337 performs the conveyance to the back side of the paper surface, and the third conveyance member 338 performs the conveyance to the front side of the paper surface.

Note that the developing roll 334, the layer regulating member 335, the first conveyance member 336, the second conveyance member 337, the third conveyance member 338, and the pickup roll 339 are arranged substantially parallel to the photosensitive drum 31 (refer to FIG. 1).

Next, a more specific configuration of the developing device 33 will be described.

FIG. 3 is a perspective view illustrating a more specific configuration of the developing device 33. Note that FIG. 3 illustrates a state in which the pickup roll 339 (refer to FIG. 2) is removed.

As illustrated in FIG. 3, the developing device 33 includes the front side member 33a positioned on the front side and the back side member 33b positioned on the rear side as members constituting a part of the accommodation case 332 (refer to FIG. 2). The front side member 33a and the back side member 33b are separated in an axial direction J of the developing roll 334. Both end portions of the developing roll 334 are rotatably held by the front side member 33a and the back side member 33b.

An inner surface 33c of the front side member 33a faces the back side member 33b, and an outer surface 33d of the front side member 33a is a surface positioned on a side opposite to the back side member 33b.

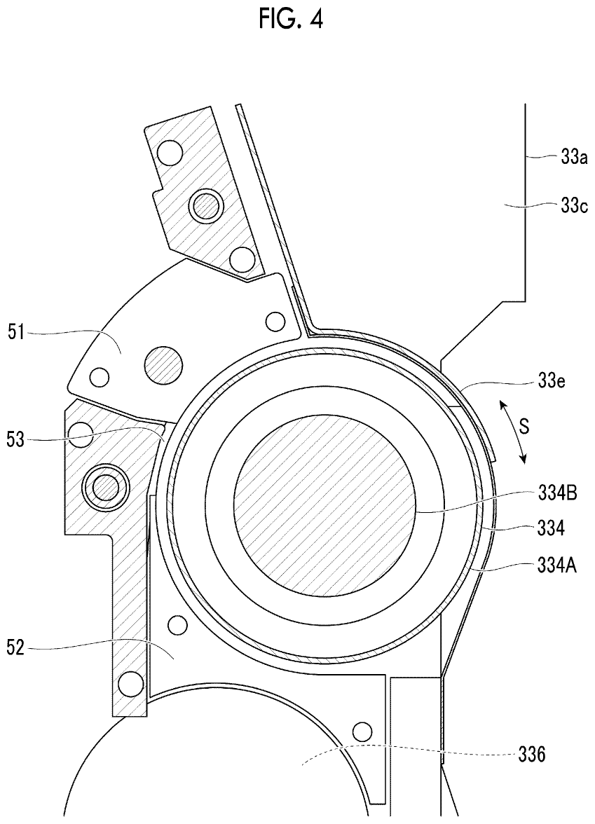

FIG. 4 is a cross-sectional view of the developing device 33 viewed from the inner surface 33c side of the front side member 33a, and illustrates the vicinity of the developing roll 334 in an enlarged manner. Note that the illustration of the first conveyance member 336 is omitted in FIG. 4.

As illustrated in FIG. 4, the developing device 33 includes a cover member 33e that covers a part of the developing roll 334 and that has a part with an arc-shaped cross section.

In addition, in the developing device 33, metal plates 51 and 52 having magnetism, and a sheet magnet 53 are provided on the front side member 33a. The metal plates 51 and 52 are arranged at different positions in an up-down direction, the metal plate 51 is positioned on the upper side, and the metal plate 52 is positioned on the lower side.

The metal plates 51 and 52 are provided at positioned adjacent to the developing roll 334, on the inner surface 33c of the front side member 33a. More specifically, the metal plate 51 is positioned closer to the cover member 33e, and the metal plate 52 is positioned between the first conveyance member 336 and the developing roll 334.

The sheet magnet 53 is provided along a circumferential direction S of the developing roll 334. The sheet magnet 53 has a part positioned between the metal plates 51 and 52 in the circumferential direction S.

A magnetic pattern is formed on the metal plates 51 and 52 by the magnetic force of the developing roll 334. The sheet magnet 53 has a magnetic pattern in one predetermined direction.

The magnetic pattern here indicates a range of magnetic force, and is the boundary and arrangement of N and S poles.

Note that the metal plates 51 and 52 and the sheet magnet 53 are provided at positions close to the developing roll 334, and the gap may be, for example, 1 mm.

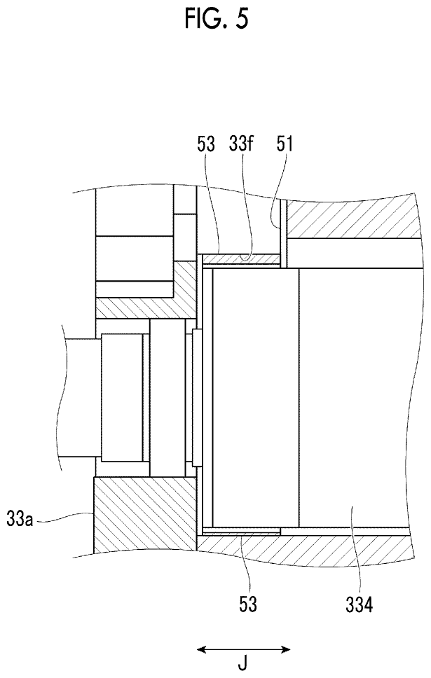

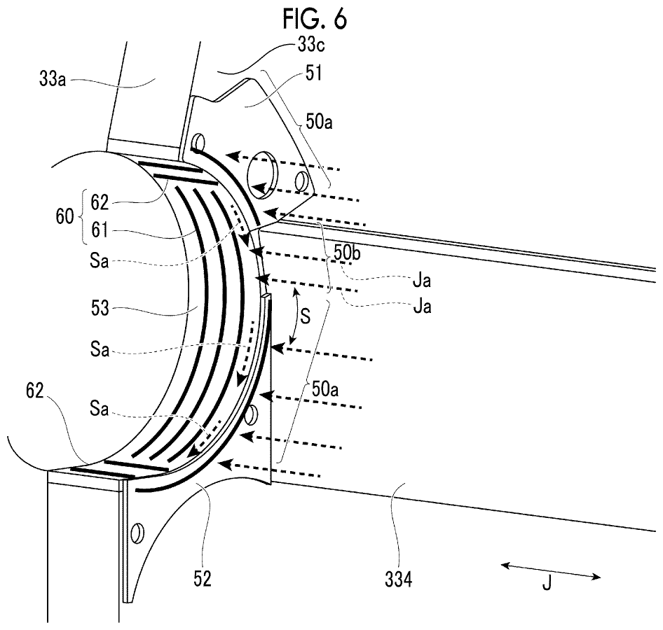

FIGS. 5 and 6 are diagrams illustrating the relationship between the developing roll 334, the metal plates 51 and 52, and the sheet magnet 53, FIG. 5 is a cross-sectional view thereof, and FIG. 6 is a perspective view thereof.

As illustrated in FIG. 5, the metal plate 51 is provided on the inner surface 33c of the front side member 33a. That is, the metal plate 51 is positioned at the end portion of the developing roll 334. Note that the illustration of the metal plate 52 (refer to FIG. 4) is omitted in FIG. 5, but similar to the metal plate 51, the metal plate 52 is positioned at the end portion of the developing roll 334.

In FIG. 5, the front side member 33a is illustrated in cross section, and the illustration of a part of the developing roll 334 beyond the front side member 33a is omitted.

In addition, the sheet magnet 53 is provided in a recess portion 33f formed on the front side member 33a. More specifically, the sheet magnet 53 is positioned between the inner surface of the recess portion 33f and the developing roll 334. The sheet magnet 53 is provided over the entire circumference of the developing roll 334.

In more detail, the recess portion 33f is positioned closer to the end portion than the metal plate 51 in the axial direction J of the developing roll 334. Therefore, the sheet magnet 53 is positioned closer to the end portion (closer to the left side in FIG. 5) than the metal plate 51.

In FIG. 6, the magnetization pattern of the sheet magnet 53 is indicated by thick lines, and the flow of toner in a floating state at the end portion of the developing roll 334 is indicated by dashed arrows. Note that, in FIG. 6, a part of the front side member 33a on the front side is omitted.

The sheet magnet 53 illustrated in FIG. 6 is provided over a region 50a where the metal plates 51 and 52 are positioned and a region where the metal plates 51 and 52 are not positioned, that is, a region 50b other than the region 50a, in the circumferential direction S.

The region 50a is an example of a second range, and the region 50b is an example of a first range.

The sheet magnet 53 has a magnetization pattern 60 that changes a plurality of times in the circumferential direction S. Such a magnetization pattern 60 is formed by combining magnets, is a range of magnetic force, and indicates the boundary and arrangement of N and S poles.

More specifically, the magnetization pattern 60 has a first magnetization pattern portion 61 formed by arranging magnetic poles of magnets in the circumferential direction S in the region 50b where the metal plates 51 and 52 are not positioned. In addition, the magnetization pattern 60 has a second magnetization pattern portion 62 formed by arranging magnetic poles of magnets in the axial direction J in the regions 50a and 50b.

In this manner, in a case of focusing on the magnetization pattern 60 in one direction in the circumferential direction S, the second magnetization pattern portion 62, the first magnetization pattern portion 61, and the second magnetization pattern portion 62 are arranged in this order, and change a plurality of times.

In more detail, instead of the second magnetization pattern portion 62 in the axial direction J, the first magnetization pattern portion 61 in the circumferential direction S is provided in the region 50b. As a result, even in a case where the toner in the floating state moves in an outward direction Ja of the axial direction J through the region 50b where the metal plates 51 and 52 are not positioned, the toner in the floating state is hindered from moving in the axial direction J by the magnetic field generated by the first magnetization pattern portion 61. In addition, even in a case where the toner in the floating state moves in one direction Sa of the circumferential direction S in the first magnetization pattern portion 61, the toner in the floating state is hindered from moving in the axial direction J by the magnetic field generated by the second magnetization pattern portion 62.

As a result, the toner in the floating state is prevented from leaking to the outside of the developing device 33 (for example, refer to FIG. 2). Note that the one direction Sa of the circumferential direction S herein includes a radial direction, and is a direction other than the axial direction J. That is, in a case where the axial direction J is referred to as a lateral direction, the one direction Sa can be referred to as a vertical direction.

In FIG. 6, all of the magnetization patterns 60 in the region 50b where the metal plates 51 and 52 are not positioned are formed by arranging the magnetic poles of the sheet magnet 53 in the circumferential direction S (first magnetization pattern portion 61), but the present disclosure is not limited thereto. That is, in a case where the above-mentioned measures against the toner in the floating state are taken, it is also conceivable that at least a part of the magnetization pattern 60 in the region 50b is formed by the first magnetization pattern portion 61.

In addition, the magnetization pattern 60 in the region 50a where the metal plates 51 and 52 are positioned is formed by arranging magnetic poles of the sheet magnet 53 in the axial direction J (second magnetization pattern portion 62), but the present disclosure is not limited thereto, and it is also conceivable that at least a part of the magnetization pattern 60 in the region 50a is formed by the second magnetization pattern portion 62.

Here, as illustrated in FIG. 6, the second magnetization pattern portions 62 of the sheet magnet 53 in which the magnetic poles of the sheet magnet 53 are arranged in the axial direction J are arranged at the most upstream side and the most downstream side of the developing roll 334 in the circumferential direction S, and are arranged closer to the metal plates 51 and 52. As a result, the toner leakage in the circumferential direction S is prevented.

Note that in the case of the developing device 33 equipped with a sheet magnet in the related art, by replacing the sheet magnet with the sheet magnet 53 according to the present exemplary embodiment, the toner leakage can be suppressed, and the cost of design changes can be suppressed.

In addition, in the present exemplary embodiment, since the magnetic force of the magnet is used, an increase in starting torque is suppressed as compared with a case where a sealing material such as a sponge is used to prevent the toner leakage.

### Various Forms of Magnetization Pattern 60

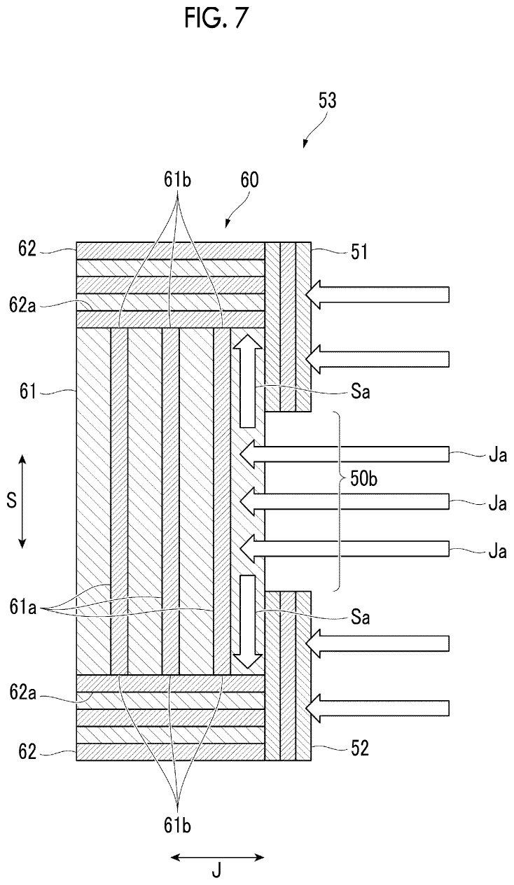

Next, various forms of the magnetization pattern 60 will be described using FIGS. 7 to 10.

FIG. 7 is a diagram illustrating a first form example of the magnetization pattern 60.

In the magnetization pattern 60, the first magnetization pattern portion 61 is formed by stacking magnet portions 61a formed in layers. In addition, the second magnetization pattern portion 62 is formed by stacking magnet portions 62a formed in layers. Such magnet portions 61a and 62a correspond to the thick lines illustrated in FIG. 6.

As illustrated in FIG. 7, the magnetization pattern 60 according to the first form example includes the first magnetization pattern portion 61 and the second magnetization pattern portion 62 described above. The magnet portions 61a in the first magnetization pattern portion 61 extend in the circumferential direction S and are stacked in the axial direction J. The magnet portions 62a in the second magnetization pattern portion 62 extend in the axial direction J and are stacked in the radial direction.

Therefore, in a case where the toner in the floating state moves to the sheet magnet 53 via the region 50b between the metal plate 51 and the metal plate 52 in the outward direction Ja, the toner in the floating state is hindered from moving in the outward direction Ja by the magnet portions 61a of the first magnetization pattern portion 61. Although the toner in the floating state of which the movement is hindered moves in the one direction Sa, the toner in the floating state is prevented from leaking to the outside of the device due to a dead end configuration by the magnet portions 62a of the second magnetization pattern portion 62 or a configuration where the route length is increased. Note that the toner leakage to the outside of the developing device 33 is suppressed not only by the magnetization pattern 60 but also by the collection of the developer caused by the magnetization pattern 60.

In more detail, in the first form example illustrated in FIG. 7, the magnet portions 62a of the second magnetization pattern portion 62 are in contact with the magnet portions 61a of the first magnetization pattern portion 61. That is, the magnet portions 62a are in contact with end portions 61b of the magnet portions 61a. As a result, the toner leakage in the axial direction J is more reliably suppressed.

Note that, in the first form example, a configuration in which the magnet portions 62a are in contact with the end portions 61b of the magnet portions 61a is adopted, but a configuration in which the magnet portions 62a are not in contact with the end portions 61b of the magnet portions 61a may be adopted. Even in such a case, leakage to the outside of the device is suppressed by the magnetic force of the magnet portions 62a.

In this manner, in the first form example illustrated in FIG. 7, the magnetization pattern 60 is formed for the region 50b where the metal plates 51 and 52 are not positioned by combining the first magnetization pattern portion 61 having a magnetization pattern in the vertical direction using the magnet portions 61a and the second magnetization pattern portion 62 having a magnetization pattern in the lateral direction using the magnet portions 62a. By the magnetization pattern 60, leakage of the floating toner in the axial direction J and the circumferential direction S through the region 50b is suppressed.

The magnetization pattern 60 of the first form example changes a plurality of times in the circumferential direction S, and at least a part of the magnetization pattern 60 in the region 50b is formed by arranging the magnetic poles of the magnet portions 61a in the circumferential direction S. In addition, at least a part of such a magnetization pattern 60 in the region 50a is formed by arranging the magnetic poles of the magnet portions 62a in the axial direction J.

The circumferential direction S in the first form example is an example of a first direction, and the axial direction J is an example of a second direction.

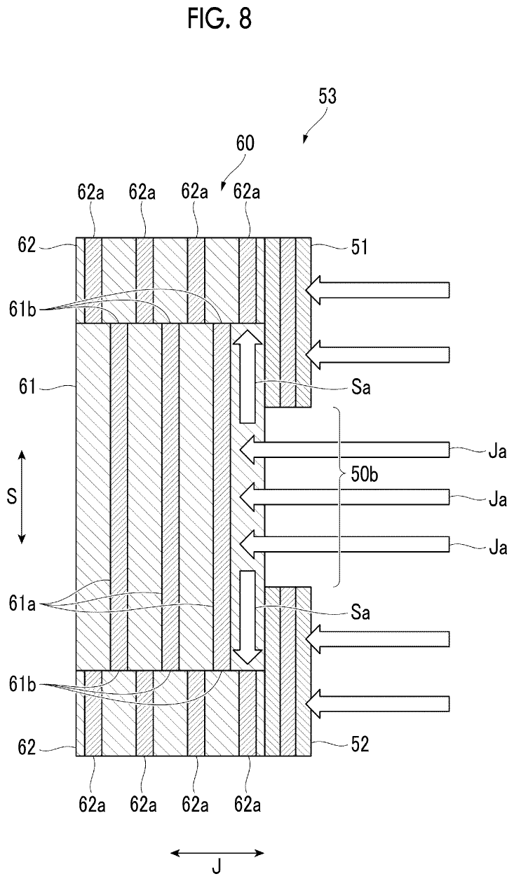

FIG. 8 is a diagram illustrating a second form example of the magnetization pattern 60. In the second form example, the same components as the components in the first form example are denoted by the same reference numerals, and the description thereof may be omitted.

As illustrated in FIG. 8, in the second form example, the magnet portions 62a of the second magnetization pattern portion 62 extend in the circumferential direction S and are stacked in the axial direction J, similar to the magnet portions 61a of the first magnetization pattern portion 61. In this respect, the second form example differs from the first form example described above.

In more detail, the stacking position of the magnet portions 62a in the axial direction J is different from the stacking position of the magnet portions 61a. That is, the magnet portions 62a are not at the same positions as the magnet portions 61a in the axial direction J, and are positioned by being shifted in the axial direction J.

Therefore, the toner in the floating state of which the movement in the outward direction Ja is hindered by the magnet portions 61a of the first magnetization pattern portion 61 does not leak to the outside of the device due to the magnetic force of the magnet portions 62a of the second magnetization pattern portion 62.

In this manner, in the second form example illustrated in FIG. 8, the magnetization pattern 60 is formed for the region 50b where the metal plates 51 and 52 are not positioned by combining the first magnetization pattern portion 61 having a magnetization pattern in the vertical direction and the second magnetization pattern portion 62 having a magnetization pattern in the vertical direction which is shifted from the first magnetization pattern portion 61 in the axial direction J. By the magnetization pattern 60, leakage of the floating toner in the axial direction J and the circumferential direction S through the region 50b is suppressed.

The magnetization pattern 60 of the second form example changes a plurality of times in the circumferential direction S, and at least a part of the magnetization pattern 60 in the region 50b where the metal plates 51 and 52 are not positioned is obtained by arranging the magnetic poles of the magnet portions 61a in the circumferential direction S.

More specifically, at least a part of the magnetization pattern 60 in the region 50b is formed by a first circumferential direction arrangement in which the magnetic poles of the magnet portions 61a are arranged in the circumferential direction S. In addition, at least a part of the magnetization pattern 60 in the region 50a where the metal plates 51 and 52 are positioned is formed by a second circumferential direction arrangement in which the magnetic poles of the magnet portions 62a are arranged in the circumferential direction S, the second circumferential direction arrangement having a different position in the axial direction J from the magnet portions 61a in the first circumferential direction arrangement.

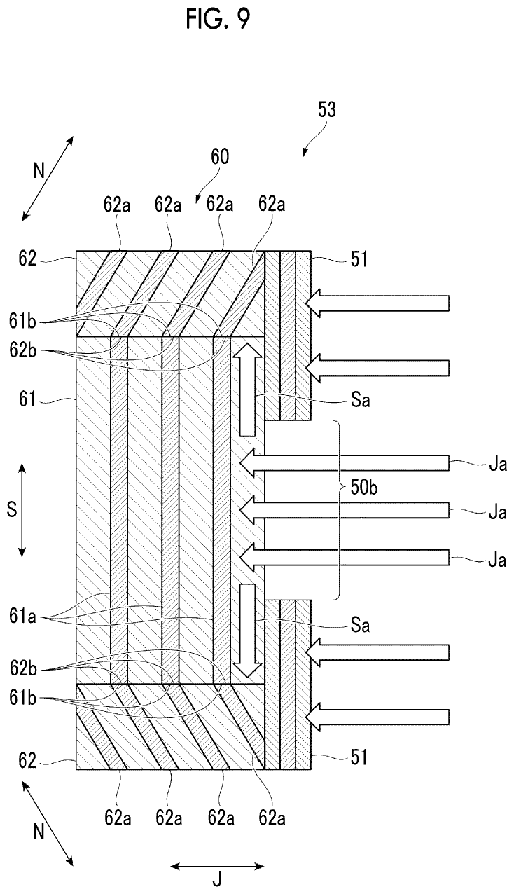

FIG. 9 is a diagram illustrating a third form example of the magnetization pattern 60.

As illustrated in FIG. 9, in the third form example, the magnet portions 62a of the second magnetization pattern portion 62 extend in a diagonal direction N, which is a direction diagonal to the axial direction J.

In this respect, the third form example differs from the first form example and second form example described above.

In more detail, the magnet portions 61a of the first magnetization pattern portion 61 are in contact with the magnet portions 62a of the second magnetization pattern portion 62. That is, the second magnetization pattern portion 62 is positioned with respect to the first magnetization pattern portion 61 such that the end portions 62b of the magnet portions 62a are connected to the end portions 61b of the magnet portions 61a. As a result, the toner leakage in the axial direction J is more reliably prevented.

Note that, in the third form example, a configuration in which the end portions 62b of the magnet portions 62a are in contact with the end portions 61b of the magnet portions 61a is adopted, but a configuration in which the end portions 62b of the magnet portions 62a are not in contact with the end portions 61b of the magnet portions 61a may be adopted. Even in such a case, leakage to the outside of the device is suppressed by the magnetic force of the magnet portions 62a.

In this manner, in the third form example illustrated in FIG. 9, the magnetization pattern 60 is formed for the region 50b where the metal plates 51 and 52 are not positioned by combining the first magnetization pattern portion 61 having a magnetization pattern in the vertical direction and the second magnetization pattern portion 62 having a magnetization pattern in a diagonally downward direction with respect to the axial direction J. By the magnetization pattern 60, leakage of the floating toner in the axial direction J and the circumferential direction S through the region 50b is suppressed.

The magnetization pattern 60 of the third form example changes a plurality of times in the circumferential direction S.

In the third form example, at least a part of the magnetization pattern 60 in the region 50b is formed by arranging the magnetic poles of the magnet portions 61a in the circumferential direction S, and at least a part of the magnetization pattern 60 in the region 50a is formed by arranging the magnetic poles of the magnet portions 62a in the diagonal direction N that is different from the circumferential direction S. The diagonal direction N different from the circumferential direction S here is a direction that intersects the circumferential direction S and the axial direction J.

The circumferential direction S in the third form example is an example of the first direction, and the diagonal direction Nis an example of the second direction.

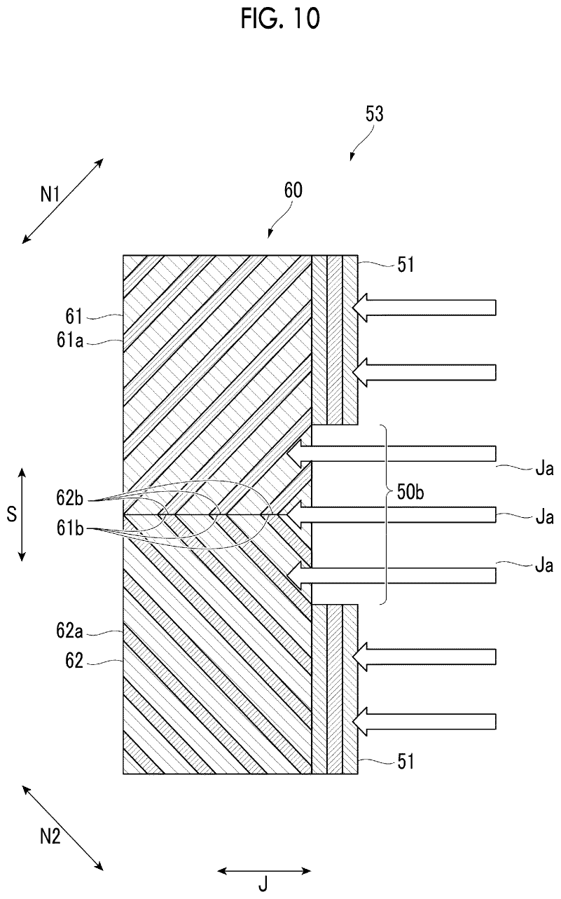

FIG. 10 is a diagram illustrating a fourth form example of the magnetization pattern 60.

As illustrated in FIG. 10, in the fourth form example, the magnet portions 61a of the first magnetization pattern portion 61 extend in a diagonal direction N1 with respect to the axial direction J, and the magnet portions 62a of the second magnetization pattern portion 62 extend in a diagonal direction N2 with respect to the axial direction J. In addition, the diagonal direction N1 and the diagonal direction N2 extend in directions intersecting each other.

Therefore, the toner in the floating state moving in the outward direction Ja through the region 50b is prevented from leaking to the outside of the device by the magnet portions 61a and the magnet portions 62a.

In more detail, in the fourth form example, the end portions 61b of the magnet portions 61a in the first magnetization pattern portion 61 and the end portions 62b of the magnet portions 62a in the second magnetization pattern portion 62 are configured to be in contact with each other. As a result, the toner leakage in the axial direction J is more reliably prevented.

Note that, in the fourth form example, a configuration in which the end portions 62b of the magnet portions 62a are in contact with the end portions 61b of the magnet portions 61a is adopted, but a configuration in which the end portions 62b of the magnet portions 62a are not in contact with the end portions 61b of the magnet portions 61a may be adopted. Even in such a case, leakage to the outside of the device is suppressed by the magnetic force of the magnet portions 61a and 62a.

In this manner, in the fourth form example illustrated in FIG. 10, the magnetization pattern 60 is formed by combining the first magnetization pattern portion 61 having a magnetization pattern in the diagonal direction N1 that is a diagonally upward direction with respect to the axial direction J and the second magnetization pattern portion 62 having a magnetization pattern in the diagonal direction N2 that is a diagonally downward direction with respect to the axial direction J, and leakage of the floating toner in the axial direction J and the circumferential direction S through the region 50b is suppressed.

In the fourth form example, at least a part of the magnetization pattern 60 in the region 50b is formed by arranging the magnetic poles of the magnet portions 61a in the direction (diagonal direction N1) intersecting the circumferential direction S and the axial direction J, and at least a part of the magnetization pattern 60 in the region 50a is formed by arranging the magnetic poles of the magnet portions 62a in the direction (diagonal direction N2) that intersects the circumferential direction S and the axial direction J and that intersects the magnetic pole direction of the magnet portions 61a.

In the fourth form example, the diagonal direction N1 is an example of the first direction, and is an example of a first intersecting direction. In addition, the diagonal direction N2 is an example of the second direction, and is an example of a second intersecting direction. Note that, as illustrated in FIG. 10, the magnetization pattern 60 according to the fourth form example has a semicircular-shaped inner surface in which one first magnetization pattern portion 61 is arranged on the upper side and one second magnetization pattern portion 62 is arranged on the lower side. In other words, in the fourth form example, in a case where the magnetization pattern 60 is observed by being divided by the horizontal plane including the center point, the first magnetization pattern portion 61 is arranged on the upper semicircular-shaped inner surface, and the second magnetization pattern portion 62 is arranged on the lower semicircular-shaped inner surface, but the present disclosure is not limited thereto. That is, in a case where the magnetization pattern 60 is divided by the vertical plane including the center point and two vertical semicircular shapes are observed, at least one of the vertical semicircular-shaped inner surfaces may be configured as illustrated in FIG. 10, and the other vertical semicircular-shaped inner surface may be configured to be upside down with respect to the one vertical semicircular-shaped inner surface. The upside down configuration here is an example in which one second magnetization pattern portion 62 is arranged on the upper side and one first magnetization pattern portion 61 is arranged on the lower side. In the case of such an arrangement example, the magnetization pattern 60 changes a plurality of times in the circumferential direction S.

### Supplementary Note

(((1)))

A developing device comprising:
a developer holder in which a stick region as a region where a developer containing toner and carrier is stuck is set excluding an end portion, and that holds the developer to be supplied to an image holder forming an electrostatic latent image, in the stick region;
a magnetic plate that is positioned at the end portion of the developer holder in a second range excluding a first range in a circumferential direction; and
magnets that are combined to form a magnetization pattern in the circumferential direction corresponding to the first range.
   (((2)))

The developing device according to (((1))),
wherein the magnetization pattern changes a plurality of times in the circumferential direction.
   (((3)))

The developing device according to (((1))) or (((2))),
wherein at least a part of the magnetization pattern in the first range is formed by arranging magnetic poles of the magnets in the circumferential direction of the developer holder.
   (((4)))

The developing device according to (((1))) or (((2))),
wherein at least a part of the magnetization pattern in the second range is formed by arranging magnetic poles of the magnets in an axial direction of the developer holder.
   (((5)))

The developing device according to (((4))),
wherein the magnets in which the magnetic poles of the magnets are arranged in the axial direction are arranged on a most upstream side and a most downstream side in the circumferential direction of the developer holder, and are arranged closer to the magnetic plate.
   (((6)))

The developing device according to any one of (((2))) to (((4))),
wherein the magnets forming the magnetization pattern in the first range and magnets forming the magnetization pattern in the second range are in contact with each other.
   (((7)))

The developing device according to (((2))),
wherein at least a part of the magnetization pattern in the first range is formed in a first circumferential direction arrangement in which magnetic poles of the magnets are arranged in the circumferential direction, and
at least a part of the magnetization pattern in the second range is formed in a second circumferential direction arrangement in which magnetic poles of the magnets are arranged in the circumferential direction, the second circumferential direction arrangement having a different position in an axial direction from the magnets in the first circumferential direction arrangement.
   (((8)))

The developing device according to (((2))),
wherein at least a part of the magnetization pattern in the first range is formed by arranging magnetic poles of the magnets in a first direction, and
at least a part of the magnetization pattern in the second range is formed by arranging magnetic poles of the magnets in a second direction different from the first direction.
   (((9)))

The developing device according to (((8))),
wherein the first direction is the circumferential direction of the developer holder, and the second direction is an axial direction of the developer holder.
   (((10)))

The developing device according to (((8))),
wherein the first direction is the circumferential direction of the developer holder, and
the second direction is a direction intersecting the circumferential direction and an axial direction of the developer holder.
   (((11)))

The developing device according to (((8))),
wherein the first direction is a first intersecting direction that intersects the circumferential direction of the developer holder and an axial direction of the developer holder, and
the second direction is a second intersecting direction that intersects the circumferential direction, the axial direction, and the first intersecting direction.
   (((12)))

An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes
a developer holder in which a stick region as a region where a developer containing toner and carrier is stuck is set excluding an end portion, and that holds the developer to be supplied to the image holder forming the electrostatic latent image, in the stick region,
a magnetic plate that is positioned at the end portion of the developer holder in a second range excluding a first range in a circumferential direction, and
magnets that are combined to form a magnetization pattern in the circumferential direction corresponding to the first range.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developer holder in which a stick region as a region where a developer containing toner and carrier is stuck is set excluding an end portion, and that holds the developer to be supplied to an image holder forming an electrostatic latent image, in the stick region;
a magnetic plate that is positioned at the end portion of the developer holder in a second range excluding a first range in a circumferential direction; and
magnets that are combined to form a magnetization pattern in the circumferential direction corresponding to the first range.

2. The developing device according to claim 1,
wherein the magnetization pattern changes a plurality of times in the circumferential direction.

3. The developing device according to claim 2,
wherein at least a part of the magnetization pattern in the first range is formed by arranging magnetic poles of the magnets in the circumferential direction of the developer holder.

4. The developing device according to claim 2,
wherein at least a part of the magnetization pattern in the second range is formed by arranging magnetic poles of the magnets in an axial direction of the developer holder.

5. The developing device according to claim 4,
wherein the magnets in which the magnetic poles of the magnets are arranged in the axial direction are arranged on a most upstream side and a most downstream side in the circumferential direction of the developer holder, and are arranged closer to the magnetic plate.

6. The developing device according to claim 2,
wherein the magnets forming the magnetization pattern in the first range and magnets forming the magnetization pattern in the second range are in contact with each other.

7. The developing device according to claim 2,
wherein at least a part of the magnetization pattern in the first range is formed in a first circumferential direction arrangement in which magnetic poles of the magnets are arranged in the circumferential direction, and
at least a part of the magnetization pattern in the second range is formed in a second circumferential direction arrangement in which magnetic poles of the magnets are arranged in the circumferential direction, the second circumferential direction arrangement having a different position in an axial direction from the magnets in the first circumferential direction arrangement.

8. The developing device according to claim 2,
wherein at least a part of the magnetization pattern in the first range is formed by arranging magnetic poles of the magnets in a first direction, and
at least a part of the magnetization pattern in the second range is formed by arranging magnetic poles of the magnets in a second direction different from the first direction.

9. The developing device according to claim 8,
wherein the first direction is the circumferential direction of the developer holder, and
the second direction is an axial direction of the developer holder.

10. The developing device according to claim 8,
wherein the first direction is the circumferential direction of the developer holder, and
the second direction is a direction intersecting the circumferential direction and an axial direction of the developer holder.

11. The developing device according to claim 8,
wherein the first direction is a first intersecting direction that intersects the circumferential direction of the developer holder and an axial direction of the developer holder, and
the second direction is a second intersecting direction that intersects the circumferential direction, the axial direction, and the first intersecting direction.

12. An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes
a developer holder in which a stick region as a region where a developer containing toner and carrier is stuck is set excluding an end portion, and that holds the developer to be supplied to the image holder forming the electrostatic latent image, in the stick region,
a magnetic plate that is positioned at the end portion of the developer holder in a second range excluding a first range in a circumferential direction, and
magnets that are combined to form a magnetization pattern in the circumferential direction corresponding to the first range.
